(19) United States
(12) Patent Application Publication
(10) Pub. No.: US 2014/0205800 A1
(43) Pub. Date: Jul. 24, 2014

(54) EXTERNALLY BONDED FIBER REINFORCED POLYMER STRENGTHENING SYSTEM

(71) Applicant: MILLIKEN & COMPANY, Spartanburg, SC (US)

(72) Inventors: Venkatkrishna Raghavendran, Greer, SC (US); Bernhard Zeiler, Moore, SC (US); Qi Liao, An Arbor, MI (US); Jeffrey Strahan, Greer, SC (US); Philip T. Wilson, Cincinnati, OH (US); Gregg J. Blaszak, Greenville, SC (US); Dale S. Kitchen, Boiling Springs, SC (US); Patrick A. Petri, Greer, SC (US)

(73) Assignee: MILLIKEN & COMPANY, Spartanburg, SC (US)

(21) Appl. No.: 14/154,264

(22) Filed: Jan. 14, 2014

Related U.S. Application Data
(60) Provisional application No. 61/755,718, filed on Jan. 23, 2013.

(51) Int. Cl. B32B 13/04; B32B 37/14; B32B 7/08

(52) U.S. Cl. CPC B32B 13/04; B32B 7/08; B32B 37/14
USPC 428/141; 428/446; 428/223; 156/60; 156/91

(57) ABSTRACT

A fiber reinforced polymer strengthening system having a concrete structural member having at least one outer facing surface. At least one pultruded element is located on the outer facing surface of the concrete structural member, the pultruded element containing a matrix material having a T_{g} of at least about 110° C. and a plurality of fibers having a tensile strength of at least about 300 MPa and an operating temperature of at least the T_{g} of the matrix material. Also located on the outer surface of the concrete member and at least partially covering the at least one pultruded element is an inorganic binder comprising an inorganic material having an operating temperature of at least about T_{g} of the matrix material of the pultruded element.

### RELATED APPLICATIONS

This application claims priority to provisional application 61/755, 718 (filed Jan. 23, 2013), which is incorporated herein in its entirety.

### TECHNICAL FIELD

The present disclosure relates generally to fiber reinforced polymer strengthening systems, more particularly to fiber reinforced polymer strengthening systems for concrete structures for added fire resistance.

### BACKGROUND

Concrete and other masonry or cementitious materials have compressive strength but substantially low tensile strength. Thus, when using concrete as a structural member, for example, in a building, bridge, pipe, pier, culvert, tunnel, or the like, it is conventional to incorporate reinforcing members to impart the necessary tensile strength. Historically, the reinforcing members are steel or other metal reinforcing rods or bars, i.e., “rebar”. Such reinforcing members may be placed under tension to form pre-stressed or positioned concrete structures.

Composite reinforcement materials, specifically fiber reinforced plastics (FRP), have been used to strengthen existing concrete and masonry structures. FRPs are strong, lightweight, highly durable, and can be easily installed in areas of limited access. These fiber reinforced polymers typically contain a glass or carbon fiber textile that is embedded in a matrix such as binder resin.

FRPs used in the concrete reinforcements are typically made with carbon fibers and epoxy. These FRP materials may not be able to withstand a fire event when the structure is subjected to fire and heat that can reach 2000° F. Due to these limitations, the FRP reinforcements are typically not considered for many structures requiring fire ratings or are designed to be secondary reinforcement carrying not more than 30% of the total load of the reinforced concrete structures. A fiber reinforced solution that can withstand the fire and heat and maintain its structural strengthening to carry a load beyond this design limitation is presently an unmet need in concrete reinforcement applications (both at time of manufacture, during retrofitting or repairing an existing structure).

### BRIEF SUMMARY

A fiber reinforced polymer strengthening system having a concrete structural member having at least one outer facing surface. At least one pultruded element is located on the outer facing surface of the concrete structural member, the pultruded element containing a matrix material having a T_{g} of at least about 110° C. and a plurality of fibers having a tensile strength of at least about 300 MPa and an operating temperature of at least the T_{g} of the matrix material. Also located on the outer surface of the concrete member and at least partially covering the at least one pultruded element is an inorganic binder comprising an inorganic material having an operating temperature of at least about T_{g} of the matrix material of the pultruded element.

### BRIEF DESCRIPTION OF THE FIGURES

An embodiment of the present invention will now be described by way of example, with reference to the accompanying drawings.

FIGS. 1 and 2 are side views of different embodiments of the fiber reinforced polymer strengthening system.

FIGS. 3 and 4 are images of a pultruded elements formed using a peel-ply textile.

FIG. 5 is a cross-sectional view of one embodiment of the insulation being attached to the concrete member.

FIGS. 6-8 are illustrative views of multiple insulation panels placed together to form the insulation layer.

### DETAILED DESCRIPTION

The fiber reinforced polymer strengthening system may be used in any cementitious system (including concrete, masonry, or brick structures) or any other suitable structure requiring additional reinforcement such as timber and steel structures. The fiber reinforced polymer strengthening system may be used in any suitable part of any suitable structure such as an architectural structures (including buildings), foundations, brick/block walls, pavements, bridges/overpasses, motorways/roads, runways, parking structures, dams, tunnels, pools/reservoirs, pipes, footings for gates, fences and poles and even boats. Preferably, the fiber reinforced polymer strengthening system and all of the structures formed using the fiber reinforced polymer strengthening system pass the ASTM E-119 test.

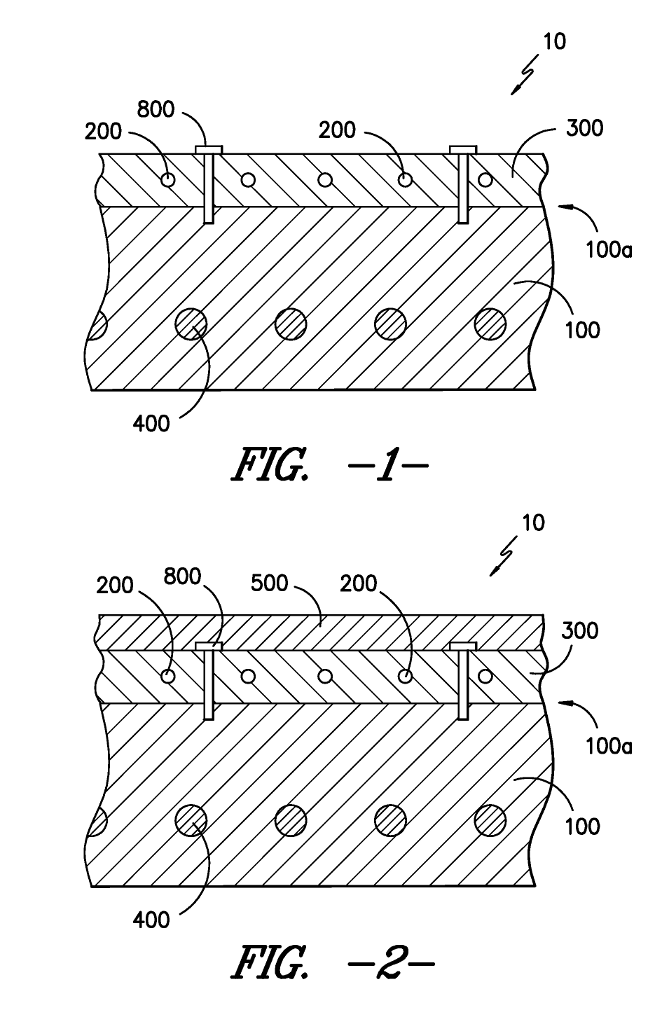

As shown in FIG. 1, the fiber reinforced polymer strengthening system 10 contains a concrete structural member 100 and an outer facing surface 100a. In this embodiment, the concrete structural member 100 also contains rebar 400 which is typically steel. On the outer facing surface is a plurality of pultruded elements 200 in an inorganic binder 300.

The concrete structural member 100 may be any suitable structural member. This includes, but is not limited to, concrete slabs, beams, joists, pillars, and columns. Concrete is a composite construction material composed primarily of aggregate, cement, and water. There are many formulations that have varied properties. The aggregate is generally coarse gravel or crushed rocks such as limestone or granite, along with a fine aggregate such as sand. The cement, commonly Portland cement, and other cementitious materials such as fly ash and slag cement, serve as a binder for the aggregate. Various chemical admixtures are also added to achieve varied properties. Water is then mixed with this dry composite which enables it to be shaped (typically poured) and then solidified and hardened through a chemical process known as hydration. The water reacts with the cement which bonds the other components together creating a robust stone-like material. Concrete has relatively high compressive strength, but much lower tensile strength. For this reason it is usually reinforced with materials that are strong in tension (often steel rebar).

The concrete structural member 100 typically contains reinforcements 400 in the form of steel or iron reinforcement bars (“rebars”), reinforcement grids, plates or fibers. In another embodiment, the reinforcements 400 may also be FRP or glass reinforced plastic (GRP) which primarily consist of fibers of polymer, glass, carbon, basalt, aramid or other high-strength fibers set in a resin matrix to form a rebar rod or grid or fibers. These rebars are installed in much the same manner as steel. The material cost currently can be higher but, suitably applied; the structures have several advantages over traditional steel solutions. FRP rebars do not require as much concrete cover as steel, due to the susceptibility of steel to corrosion, either by intrinsic concrete alkalinity or by external corrosive fluids that might penetrate the concrete.

To strengthen and increase the load bearing capacity of the concrete structural members when subjected to flexural loading (e.g. tensile surfaces of beams, slabs) or compressive loading (e.g columns), the aforementioned strengthening systems are typically attached to the concrete structural members on the surface experiencing tensile or shear stresses. The pultruded elements are attached in a manner that effectively transfers the load from the concrete to the pultruded elements.

The concrete structural member 100 contains at least one outer facing surface 100a. The outer facing surface preferably is in tension. The pultruded members are attached to the outer facing surface with an inorganic matrix, hence this technique can be termed “externally bonded”. To prevent delamination of the inorganic matrix containing the pultruded members, fasteners are typically used to anchor the composite to the outer facing of the concrete member.

In one embodiment, more than one pultruded element is externally bonded to the outer facing surface. The pultruded elements may be attached to the concrete member as independent elements or as a bundle of elements. This bundle may consist of two elements, three elements, four elements, or 5 or more elements. A bundle of elements may be formed through several formation techniques, including formed into a textile or network including but not limited to woven, knit, nonwoven, unidirectional, and scrim textiles. Alternatively the bundle may be formed using adhesives and binders. In one embodiment, the bundle is formed with binders that retain their strength to at least as high as the epoxy T_{g} of the individual elements.

In another embodiment, the bundle of pultruded elements is formed using mechanical spacers periodically placed along the length of the elements. In one embodiment, mechanical spacers separate the individual elements. The spacers may be located every two feet or more along the length of the pultruded elements, or every 1 foot or more, or every six inches or more or every 2 inches or more. The spacers may be placed more frequently along portions of the length, such as near the ends of the pultruded elements. In some embodiments, the spacers also act as an insertion piece to help hold the bundle of pultruded elements on the outer surface of the concrete member while the inorganic binder is curing. The spacers may consist of metal, plastics, or ceramic materials. Various washers, ferrules, compression fittings, wedges or machined parts may be used to provide spacing and clamping to each element. In one embodiment, the clamping mechanism at each spacer tightens as the pultruded member is placed in tension.

The pultruded elements may be made of any suitable materials and include a plurality of fibers and a matrix material. The fibers are preferably made of a material having a high tensile strength. In one embodiment, the fibers have a tensile strength of greater than about 300 MPa, more preferably greater than 500 MPa, more preferably greater than 1000 MPa. In one embodiment, the fibers have an operating temperature at least as high as the T_{g} of the matrix material. In another embodiment, the fibers have an operating temperature more than about 50° C. above the T_{g} of the matrix material, preferably more than about 100° C. above the T_{g} of the matrix material, preferably more than about 150° C. above the T_{g} of the matrix material. In another embodiment, the fibers have an operating temperature of greater than about 250° C., more preferably greater than about 400° C. In this application, “operating temperature” is defined to be the temperature at which the material still maintains 50% of its strength properties. High modulus materials such as steel, carbon, basalt, aramid, polybenzoxazole (PBO), and glass fibers are suitable for many strengthening applications. Carbon fiber is preferred due to its high strength, modulus, and low creep. The fibers may contain a single type of fiber material, or a mixture of different fiber materials.

In addition to the fibers, the pultruded elements 200 also contain a matrix material. The fibers preferably have a good bond with the matrix material to allow for transfer of the tensile load between fibers. For example, chemical sizing on the fibers can enhance the matrix bond to the fibers. Previously lower glass transition temperature (T_{g}) matrix materials, such as lower T_{g} epoxy have been used in pultruded elements. When lower T_{g} materials are used as the matrix material, the operating temperature of the pultruded element and the entire fiber reinforced polymer strengthening system is lower and thus may be unsuitable to systems designed to withstand a fire event. Preferably, the matrix material has a T_{g} of at least about 110° C., more preferably at least about 150° C., at least about 180° C., at least about 200° C., at least about 250° C., at least about 270° C., or at least about 300° C. The matrix material may be any suitable high T_{g} matrix material, for example, epoxies, epoxy novolacs, cyanate esters, or phenollics. Some high temperature thermoplastic materials may also be considered for the matrix material such as polyimides, polyether ether ketone (PEEK), polyamide imide (PAI), polysulfones, nylons, polyesters, polycarbonates, polyolefins, or the like. For some materials that do not have a glass transition temperature (T_{g}), a melting temperature (Tₘ) may be substituted. Typically, curing at high temperature is required to achieve a glass transition above the target operating temperature of 200° C., and therefore it is preferable to be able to cure the pultruded elements in controlled environments instead of the work site. Typical carbon fibers are approximately 6.6 microns in diameter. The fiber content by volume of the pultruded element is preferably at least 40 wt %, more preferably at least 50 wt %, and more preferably at least 60 wt % of the fiber.

The pultruded elements 200 may have any suitable cross-sectional shape, diameter, and length. In one embodiment, the pultruded elements 200 have a circular cross-sectional shape and are typically referred to as pultruded rods. In another embodiment, the pultruded elements 200 may have a non-circular cross-section which may be, but is not limited to, elliptical, rectangular, square, multi-lobal, and any of the aforementioned shapes with mechanically modified features, such as by embossing, cutting, or machining. Circular shape is preferred for some embodiments for ease of manufacture and handing as well as high packing of fiber into a given volume. In another embodiment, the pultruded elements have a rectangular cross-sectional shape which is preferred in some embodiments for providing a higher surface area to bond the pultruded element to the inorganic matrix and ease of manufacturing. Pultruded elements with a rectangular cross-sectional shape are also sometimes referred to a strips, ribbons, or tapes. In one embodiment, the rectangular cross-section may have a height at least 1 times the width. In another embodiment, the pultruded elements are hollow, which could include round or rectangular cross sections or partially open c- or u-shaped cross-sections. A hollow or partially open cross-section has the advantage that additional materials could be embedded, such as a high heat capacity or phase change material to keep the elements from heating as quickly. In addition, the hollow shape may allow for filling the inorganic binder into the hollow member. Optionally holes could be added or a c- or u-shaped element to allow the inorganic binder to fill hollow shape. In one embodiment, the pultruded elements 200 have a length at least about two times the development length. The development length is the shortest length of the reinforcing rod or strip to develop its full contribution within its binder to the moment capacity of the structure. The development length is dependent on the shear strength between the binder and the reinforcement element, the tensile strength of the element, and its cross-sectional dimensions. The pultruded elements 200 have a length and a width (the width is the average width of the cross-sectional shape) and have a width to length aspect ratio of at least about 1:10.

A conventional pultrusion process involves drawing a bundle of reinforcing material (e.g., fibers or fiber filaments) from a source thereof, wetting the fibers, and impregnating them (with the matrix material) by passing the fibers through a resin bath in an open tank, pulling the resin-wetted and impregnated bundle through a shaping die to align the fiber bundle, manipulating it into the proper cross-sectional configuration, and curing the resin in a mold while maintaining tension on the filaments. Because the fibers progress completely through the pultrusion process without being cut or chopped, the resulting products generally have exceptionally high tensile strength in the longitudinal direction (i.e., in the direction the fiber filaments are pulled). Exemplary pultrusion techniques are described in U.S. Pat. No. 3,793,108 to Goldsworthy; U.S. Pat. No. 4,394,338 to Fuwa; U.S. Pat. No. 4,445,957 to Harvey; and U.S. Pat. No. 5,174,844 to Tong.

A strong bond is needed between the pultruded element 200 and inorganic binder 300. To enhance the interfacial bond, methods have been developed to enhance the surface area of the pultruded elements 200 by giving the pultruded element 200 a roughened surface texture, including embedding sand or small particles into an outer layer of the polymer at the surface of the pultruded reinforcement, winding additional glass or carbon fibers around the reinforcement embedded in the polymer, or adding ribs or other structural shapes to the cross section of the pultruded member 200. In one embodiment, the pultruded elements 200 comprise sand covering at least a portion of the surface of the pultruded element, wherein the sand is adhered to the pultruded element using the matrix material of the pultruded element 200 or another adhesive material having a high T_{g} (the adhesive preferably has a T_{g} of at least about the T_{g} of the matrix material or at least about 110° C.). In another embodiment, the pultruded elements 200 may have bends, notches, or accordion shapes on the ends (along the length direction) of the pultruded elements 200 to prevent or reduce slippage of the pultruded elements 200 within the system 10.

In another embodiment mechanical anchors can be added along the length, such as compression fittings, ferrules, gaskets, washers, spacers, shaft collars, tube fittings (including Yor-Lok, Swagelok, quick assembly fittings, and other compression or teeth-lock tube fittings), wedges, crimpable fittings, locking or tightening assemblies, and rope and braid clamps and grips. In one embodiment a machined wedge assembly can be used that tightens around the round or rectangular elements as the element is placed in tension. These anchors can be spaced periodically along the length of the element or placed only at specific locations, such as the ends of the elements. In addition, the mechanical anchors can help hold the element during installation.

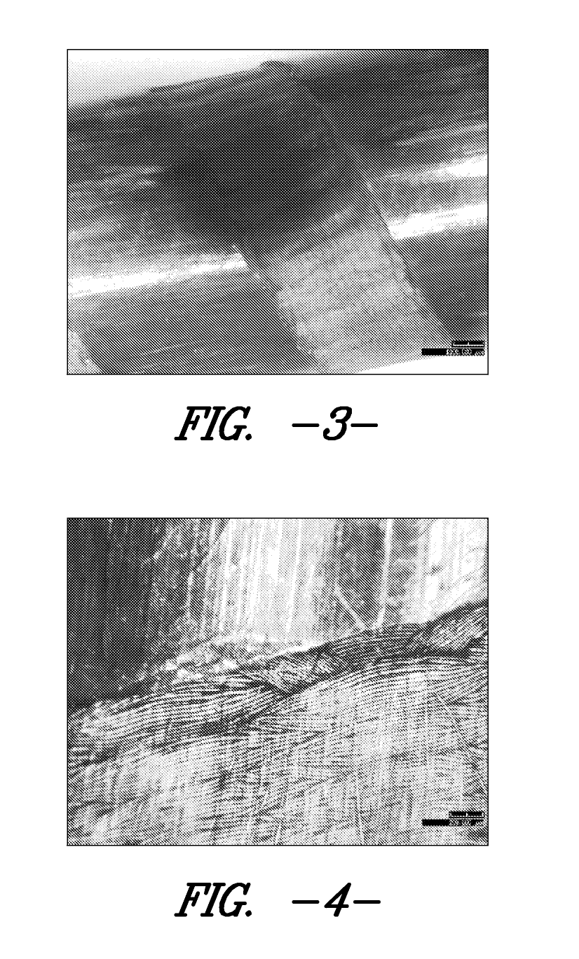

The pultruded element may also be machined in such a way to create a spiral indentation along the length direction of the member. This would yield an element that looks like a traditional steel reinforcement. In one embodiment, a pultruded member is given surface roughness with a peel-ply textile. The peel-ply can be removed after the pultrusion step to yield a spiral indentation on the pultruded member. Images of one embodiment of a pultruded element having a spiral indentation from a peel-ply fabric are shown in FIGS. 3 and 4. The peel-ply textile may yield a spiral indentation, creating a portion of the surface with a raised area (lug) and a portion of the surface with an indented area (groove). The spiral indentation can be defined by the wrapping angle or pitch and can be varied from nearly perpendicular to the length of the pultruded element (0 degrees) to running nearly parallel to the length of the rod (90 degrees). Preferably, the wrapping angle is no less than 5 degrees and no more than 60 degrees. The width of the peel-ply textile used can be from 0.005 inch to 2 inch. In one embodiment, the peel-ply textile has a width no less than 10% of the diameter of the pultruded member and no greater than 200% the diameter of the pultruded member. More preferably the width of the peel-ply is no less than 25% of the diameter of the pultruded member and no greater than 100% the diameter of the pultruded member. The ratio of the lug to the groove is set by the wrapping angle or pitch and width of the peel-ply. Preferably, the ratio of the surface area of the lug to the surface of the groove is no less than 0.1 and no greater than 10. More preferably the ratio is no less than 0.5 and no greater than 3. The thickness of the peel-ply and hence the depth of the spiral indention or groove can be from 0.001 inch to 0.125 inch. In one embodiment, the thickness of the peel-ply is no less than 0.1% of the diameter of the pultruded member and no greater than 12.5% of the diameter of the pultruded member. More preferably, the thickness of the peel-ply is no less than 1% of the diameter of the pultruded member and no greater than 6% of the diameter of the pultruded member. In other embodiments, the peel-ply could be a ribbon, a fiber, a yarn and could have texture and shape. In addition, multiple wraps can be applied simultaneously with the same or varying wrapping angle, width and thickness, and could have the same spiral handedness or opposing handedness.

The inorganic binder 300 may be any suitable binder that is suitable for the end use. The inorganic binder, also referred to as a grout or mortar, is used to achieve binding when the pultruded elements 200 are attached to the concrete structural member 100. In one embodiment, the inorganic binder contains an inorganic matrix made with sand mixed with hydraulic cements such as Ordinary Portland Cement (OPC) or acid base cements such as magnesium phosphates, aluminosilicates and phosphosilicates. Admixtures such as setting accelerators, retarders, and super plasticizers are added to these grouts and mortar mixes to tailor their setting and curing times and strength. To effectively transfer the stresses from the concrete to the reinforcement, these inorganic binders should develop sufficient early compressive strength equal to or greater than the concrete compressive strength in a short period. Additionally, to maintain the composite action these inorganic binders should be able to achieve intimate contact with the concrete structural member and preferably are low- or non-shrinking to preclude debonding from either the concrete substrate or the pultruded element embedded inside it. The inorganic binder 300 preferably has an operating temperature of at least about the Tg of the matrix material. In another embodiment, the inorganic binder has an operating temperature more than about 50° C. above the T_{g} of the matrix material, preferably more than about 1000° C. above the T_{g} of the matrix material, preferably more than about 150° C. above the T_{g} of the matrix material. In another embodiment, the inorganic binder has an operating temperature of greater than about 200° C., more preferably greater than about 500° C. The inorganic binder 300 is also preferably incombustible. The inorganic binder may be, for example, cementitious material high temperature epoxy grouts containing inorganic aggregates, pozzolanic minerals, polysialate geopolymers, and phosphate based chemically bonded ceramics. Preferably, the inorganic binder 300 comprises a cementitious material. Cementitious material is preferred for its incombustibility, fire resistance, bonding ability to concrete, and cost. In one embodiment, the concrete structural element contains pores and at least a portion of the inorganic binder penetrates in those pores.

In one embodiment, the binder is not inorganic but is an organic material having a very high T_{g} or operating temperature. Several alternative organic resins can be considered, such as anhydride-cured epoxies, cyanate ester, and phenolic resins. Additional inorganic resins might also be used, such as metal matrices, ceramics, cementitious mixtures, and geopolymers. In addition, for pultruded members, high temperature thermoplastics such as carbon pitch or engineered resins could be used.

Referring back to FIG. 1, both the pultruded elements 200 and the inorganic material 300 are located on the outer surface 100a of the concrete structural member 100. This may be accomplished in a variety of methods. The pultruded elements 200 may be attached with the aid of optional fasteners. The fasteners can be used to hold the pultruded elements 200 against gravity and to set the correct depth of the pultruded elements 200. Because the pultruded elements 200 can be much lighter than traditional steel members, simple, lightweight fasteners can be employed. The FRP members can be attached either before or after application of the inorganic binder 300, but may require fastening support until the matrix material has cured or set. In one embodiment, the pultruded elements 200 are introduced first followed by the inorganic binder 300. In another embodiment, the inorganic binder 300 is introduced first followed by the pultruded elements 200. In another embodiment, the pultruded elements 200 and the inorganic binder 300 are introduced simultaneously. In another embodiment, the outer surface is partially covered with the inorganic binder 300, then the pultruded elements 200 are introduced, then the pultruded elements are covered with additional inorganic binder 300. Preferably, the pultruded elements 200 and inorganic binder 300 are added such that the inorganic binder 300 surrounds the pultruded elements 200. “Surrounds” in this application means that essentially all (preferably at least 95%) of the surface area of the pultruded element is covered by the inorganic binder. If there are air bubbles between the pultruded elements and the inorganic binder, this may adversely affect the strengthening of the system.

A typical, externally applied reinforcement to a concrete slab, beam or joist can span up to 25 feet or more and may have several, parallel reinforcement members, such as surface mounted carbon fabric layers. Optimally a continuous length of reinforcement should be applied over the entire span and installation of each member should be uninterrupted so the bonding matrix does not set up until the installation of the member is complete. Alternatively, shorter, overlapped, reinforcement segments can be applied to cover the entire span. The working time of the inorganic binder should exceed the time required to bond at least one length of the reinforcement and preferably several lengths of the reinforcement segments prior to setting up. To that end a faster application rate of inorganic binder would allow the use of a faster setting grout and a slower application rate of the inorganic binder will require a grout with a longer working time. Wet pumping distance also dictates the working time of an inorganic binder. In all cases, the installation method and inorganic binder should allow for effective encapsulation of the pultruded FRP member. The following describes methods for installing the matrix to try to get encapsulation of a FRP member in the EB method.

Trowelling is the most commonly used method to apply inorganic binder. This application method requires an inorganic binder with sufficient working time (preferably greater than 45 minutes). Mixing of the inorganic binder and its application is typically a manual process, subject to human error. The wet inorganic binder should flow around the entire reinforced member. Alternatively, the inorganic binder can be applied first to partially cover the surface and the strengthening member can be inserted into the partially filled slot. The surface can then be covered by troweling around the strengthening member into the remaining void space. Trowelling requires no special equipment and is therefore one of the simplest approaches to applying the inorganic binder.

Caulking is used both in tuck pointing brick for grouts and mortars and in caulking of epoxy in many applications. A caulked grout is typically a one part system though it can be a two part system, while epoxy adhesives are typically two-part systems. The inorganic binder can be prepared as a batch or continuous process. A one-part inorganic binder is pre-mixed to its wet state. Two part grouts combine a non-setting paste with a liquid activator right at the nozzle. Such a system is packaged much like a two component epoxy system and can be run through a static mixing nozzle when applied. Because the curing reaction starts when the paste and the activator mix in the static mixing nozzle, a faster setting inorganic binder can be used when using this method.

The caulking process for externally bonded technique can be improved by additional tools or approaches. For example, a trowel like fixture can be attached to the caulking nozzle orifice to force the grout to stay on the surface and travel part way along the surface thus ensuring complete coverage of the surface as well as controlled depth of inorganic binder in the slot. The consistency of the inorganic binder should be such that it does not fall off of the overhead surface once it has been caulked onto the surface. Furthermore the grout cannot harden too much during the grouting operation. For caulking, the rod can be placed on the surface using spacers to ensure the proper gap around the rod and to prevent the rod from falling out during the caulking operation, as described above.

Inorganic binder can be mixed to fill a caulking tube or a continuous pumping system can be employed. For pumping, typically the inorganic binder is mixed at the pump inlet then pumped through a hose to the application tool. The inorganic binder consistency should be balanced to allow for pumpability as well as good wet-tack once applied to the concrete substrate. Short runs are typical as longer pumping runs require lower viscosity grouts which lose their wet-tack and fall out of overhead installations. Piston pumps can be used to pump higher viscosity grouts over shorter distances

In addition to caulking, pumping is typically used for delivering cement components to gunning nozzles or for delivering mixed concrete into formwork. Spraying or gunning is the process of spraying cement or inorganic binder onto a substrate.

For spraying, the inorganic binder is delivered either wet or dry to the spray nozzle. Wet slurries are mixed prior to the pump then delivered as a slurry to the nozzle along with compressed air to propel the slurry onto a substrate. Dry delivery systems pneumatically transport dry powder inorganic binder to a nozzle, along with the activator, be it water or acid, and compressed air to pneumatically mix the dry powder with the activator in the nozzle and to propel the mixture pneumatically onto the substrate.

To fill an area with the inorganic binder, a form work can be placed over the surface to be filled so as to seal the area for pumping along its length. With a form work in place, the inorganic binder can be pumped filling from one end of the area and exits the other end. The form work must be placed over the area so that it can seal off the area during the pumping operation. In one embodiment, a form material is bonded to the concrete face. Several adhesive options can be used to bond the form material to the concrete allowing the form material to span across the area to be filled. The bond of the adhesive must be strong enough to hold the form in place during the pumping operation. However, once the inorganic matrix is pumped and cures in place, the adhesive bond does not require permanent strength. The form material and adhesive can be left in place or removed after the binder has cured sufficiently, but in either case does not have to function as a structural component of the system. Adhesive materials can include adhesive liquids or pastes such as epoxies or urethanes, including fast-curing adhesives; or pressure-sensitive tapes and foam tapes, such as double sides acrylic foam tapes, or various mastics, such as blends of butyl-rubber adhesive tapes. The form material and adhesive can be a single system, such as a reinforced tape material that spans across the area, or the form material may be separate from the adhesive. Form materials may include flexible or semi-flexible textiles (including wovens, knits, or non-wovens), films, or foils; or the form may be rigid and semi-rigid boards or sheets of plastics, metals, woods, or glass. In one embodiment, the form material is a tape backing with scrim reinforcement. In another embodiment, the form material is a transparent or semi-transparent clear film bonded with a butyl-rubber adhesive. In another embodiment, the form material is a transparent or semi-transparent plastic sheet. Transparent or semi-transparent form materials provide the advantage of visual confirmation of the pumping operation as the area is being filled with the inorganic binder. Other form materials may be used to provide other benefits, such as metal sheeting or insulation board materials to provide enhancement to the heat shielding of the system. Alternatively, low cost hardboard or wood materials may be used. In other embodiments, textiles or membranes that hold liquid water but breathe water vapor can be used to tailor the curing process of the inorganic binder.

As shown in FIGS. 1 and 2, mechanical fasteners 800 are preferably used to attach or anchor the inorganic matrix to the concrete member. This mechanical means may be any suitable mechanical fastener for the end use including but not limited to concrete nails, pins, screws, nails, bolts, nuts, washers, screws, stud anchors, removable bolt anchors, high strength drive anchors, pin-drive anchors, internally threaded anchors, toggle anchors, spikes, rivets, and staples. These mechanical fasteners can be attached while the inorganic matrix is in an uncured state, a fully cured state, or in between an uncured or fully cured state. The fasteners are placed to prevent debonding should a thermal event occur or a stress be placed on the structural member. These fasteners can be placed around the edge of the where the inorganic matrix and pultruded members or in between pultruded members. They may be placed in a regular pattern or an irregular pattern. The preferred spacing is 1 fastener every 6-12″. The fasteners should be placed into the concrete so that the fasteners are appropriately anchored; this is typically on the order of ½″-2″. During a fire event and under a load, the inorganic binder can delaminate from the concrete member before sufficient strengthening occurs. The fasteners prevent this premature failure mode and ensure proper strengthening.

Referring now to FIG. 2, there is shown another embodiment of the fiber reinforced polymer strengthening system 10 having a concrete structural member 100 having an outer surface 100a and adjacent the outer facing surface 100a is the inorganic binder 300 with a plurality of pultruded elements 200 within the inorganic binder 300. FIG. 2 also shows the optional insulation layer 500 over the inorganic binder 300 providing further fire protection. The pultruded elements 200 may be single elements or may be formed into a textile or network including but not limited to woven, knit, nonwoven, unidirectional, and scrim textiles.

The insulation layer 500 may be any suitable insulation layer 500 formed of any suitable material, weight, and thickness. The insulation layer 500 preferably has an operating temperature of at least about 1000° C. at one face. In another embodiment, the insulation layer preferably keeps the interface temperature (temperature taken at the outer surface 100a of the concrete structural member 100) below 250° C. for at least 120 minutes (more preferably at least 180 minutes, more preferably at least 240 minutes) while the front side of the insulation layer (side of the insulation layer 500 facing away from the concrete structural member) was held at 1100° C. Preferably, the insulation layer is self-supporting, durable to handling and impact, and resistive to environment.

In one embodiment, the insulation layer contains a majority of ceramic fibers by weight and a minority of organic binding agents by weight such as insulation layers which can be purchased commercially as DURABOARD® from Unifrax or SUPERWOOL® from Morgan Thermal Ceramaterials.

In another embodiment, the insulation layer 500 may contain an intumescent paint which swells to at least several times its original thickness when exposed to the heat of a fire forming an insulating layer of carbonaceous char, such as CLAD® TF from Albi Manufacturing. In another embodiment, the insulation layer 500 may contain a refractory fiber blanket, such as the Flexible Ceramic Insulation from McMaster Carr. In another embodiment, the insulation layer 500 may contain a semi rigid board made from molten volcanic rock which is spun into fine threads (rockwool), impregnated with a binder and compressed to form a durable structure, such as DRICLAD® board from Albi Manufacturing.

In another embodiment, the insulation layer 500 may contain a cementitious fireproofing insulation material that consists of one or all of cement, vermiculite, gypsum, fibers, light weight aggregates, etc., such as PYROCRETE® 241 from Carboline or MONOKOTE® Z146 from Grace. In another embodiment, the insulation layer 500 may contain an aerogel insulation blanket coated with a layer of cementitious fireproofing material. An example of such aerogel insulation is PYROGEL® XT from Aspen Aerogel. In another embodiment, the insulation layer 500 may contain a light weight cement based composite which contains a cementitious matrix such as Portland cement and light-weight, porous aggregates which create structural porosity and increase insulation value. Such aggregates may include hollow glass spheres such as 3M Glass Bubbles K15. In another embodiment, the insulation layer 500 may contain gypsum board. In another embodiment, an insulation board is coated with an intumescent paint on the outside surface. In another embodiment, an intumescent coating may be applied to a fibrous, open blanket. The coating gains additional depth in the blanket when consolidated to its final thickness, effectively creating a fiber reinforced intumescent composite on the surface of the fiber board. Alternatively, an intumescent coating may be applied to fibers directly during the process to form staple fiber into a blanket or board assembly. In another embodiment, fire retarding agents can be applied, such as in a powder form into a high temperature insulation blanket, such as a flexible ceramic blanket from Morgan Thermal Ceramics. In another embodiment, the insulation layer 500 may contain gypsum board or a magnesium oxide board.

In one embodiment, the insulation contains at least one layer of a mineral fiber or refractory blanket adjacent the groove containing the reinforcing element. This blanket is then covered with one or more moisture bearing mineral boards that can optionally have a reflective radiant barrier like aluminum foil attached to one or both surfaces. The moisture bearing mineral board preferably keeps the reinforcing element 200 below 200° C. for at least 60 minutes (more preferably at least 120 minutes, more preferably at least 180 minutes, more preferably at least 240 minutes) during an ASTM E119 fire test. The board is self-supporting, durable to handling and impact, and resistant to environmental exposure. The moisture bearing mineral board can be a Gypsum board such as fire rated Type X or Type C board or Magnesium oxide boards.

The insulation layer could be a combination of any of the above listed categories of insulation materials or any other suitable insulating materials. The detailed thickness and sequences of construction of different insulations will be based on considerations such as cost, durability, installation as well as desired duration of protection from fire. The thickness of the insulation layer is typically between about 1/16″ and 3″.

In one embodiment, the insulation layer 500 is bonded to the outer surface of the concrete structural member 100 covering at least a portion of the pultruded elements and the inorganic binder. Preferably, the insulation layer 500 covers essentially all of the pultruded elements 200 and the inorganic binder 300. The insulation layer 500 should be attached to the outer surface 100a of the concrete structural member 100 such that the protection remains intact during a fire event. Various high temperature adhesives as well as mechanical fasteners may be used to ensure adequate bond. In addition, the insulation itself should have sufficient integrity during the fire event to not fall apart or debond from itself. For combinations of insulation materials, the bond of the layers should be adequate that each layer remains attached to the underside of the concrete beam or slab. In one embodiment, the adhesive is the same binder as the inorganic binder 300 used in the fiber reinforced polymer strengthening system 10. In this embodiment, the insulation layer is attached before the inorganic binder fully cures and the inorganic binder also serves to adhere the insulation onto the surface of the concrete member. In another embodiment, the adhesive may also be selected from the group of materials listed as being acceptable as inorganic binders 300 for the system 10. In one embodiment, the adhesive used to bond the insulation layer 500 and the concrete structural member 100 has a T_{g} of at least about the Tg of the matrix material. In another embodiment, the adhesive has an operating temperature more than about 50° C. above the T_{g} of the matrix material, more preferably greater than about 150° C. above the T_{g} of the matrix material. In another embodiment, the adhesive has an operating temperature of greater than about 250° C., more preferably greater than about 500° C.

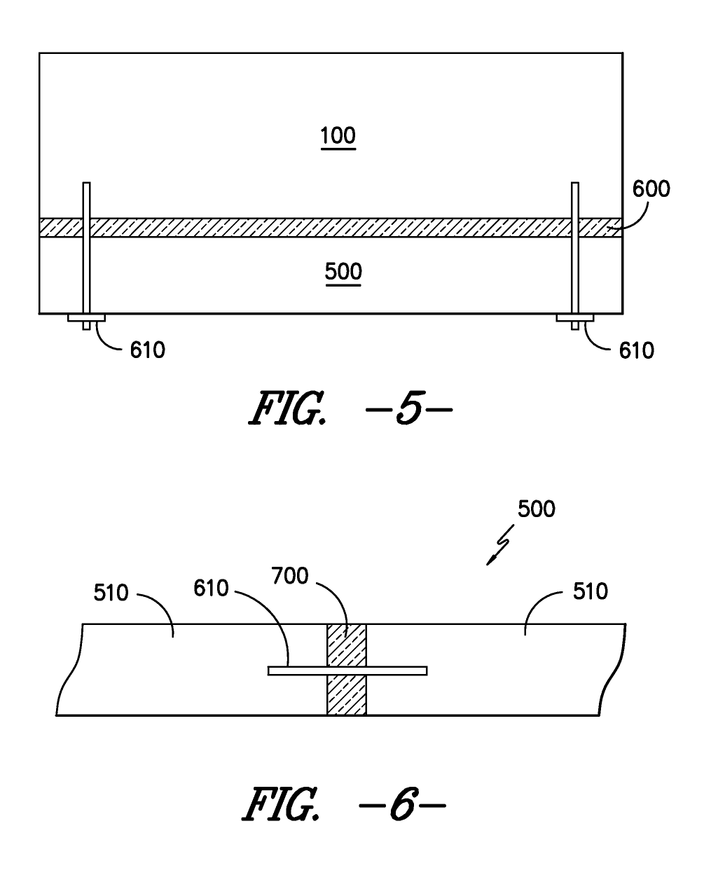

In one embodiment, there may optionally be an intermediate layer (shown as layer 600 in FIG. 5) which facilitates the bonding or intimate contacting between the insulation layer 500 and the concrete structural member 100 (and the pultruded elements and inorganic matrix, not shown).

In another embodiment, the insulation layer 500 is attached to the outer surface 100a of the concrete structural member 100 by a mechanical means. This mechanical means may be any suitable mechanical fastener for the end use including but not limited to concrete nails, pins, screws, nails, bolts, nuts, washers, screws, stud anchors, removable bolt anchors, high strength drive anchors, pin-drive anchors, internally threaded anchors, toggle anchors, spikes, rivets, and staples. In another embodiment, both an adhesive and a mechanical means are used to adhere the insulation layer 500 to the outer surface 100a of the concrete structural member 100. The mechanical fasteners might be covered with an intumescent coating or ceramic fiber paste to provide a level of thermal protection.

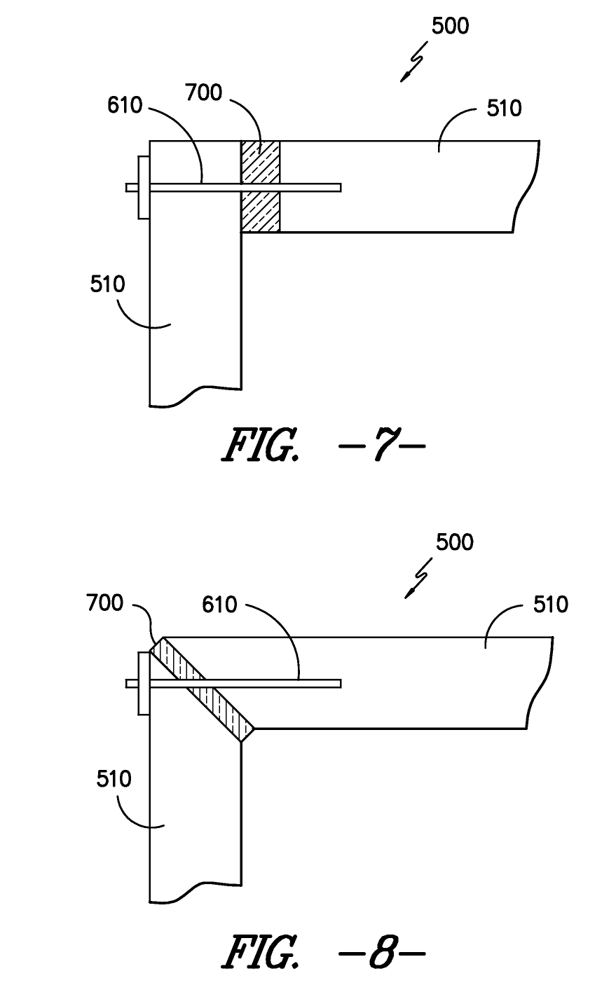

In other embodiments as shown in FIGS. 6-8, the insulation layer 500 may be formed from multiple insulation panels 510. The insulation panels 510 may be attached by any of the mechanical means 610 used to attach the insulation layer 500 to the concrete member 100. The insulation layer 500 may contain gaps or cracks between the insulation panels 510 which may be filled with a coating 700. (The coating 700 is shown larger than typical size for easier view-ability). The coating 700 is preferably an intumescent coating, a ceramic fiber paste, or other high temperature insulation material that can be applied to fill small gaps and seams. In addition, seams between insulation panels can be butt seams, or the panels can be cut or formed to make lap, miter or other seams that help increase a pathway for heat to transfer through the seams.

One process to form a fiber reinforcing polymer strengthening system begins with obtaining a preformed and cured concrete structural member having at least one outer face. The outer facing surface is preferably prepared or grinded to remove weakly bound concrete. The process preferably begins with preparing the surface of the concrete member. This can be needle scaling, grinding, sand blasting, or other approaches which remove dust and leave exposed aggregate in the concrete. In one embodiment, the pultruded elements 200 are attached first followed by the inorganic binder 300. In another embodiment, the inorganic binder 300 is introduced first followed by the pultruded elements 200. In another embodiment, the pultruded elements 200 and the inorganic binder 300 are introduced simultaneously. In another embodiment, the surface is partially covered with the inorganic binder 300, then the pultruded elements 200 are introduced onto the surface, then the rest of the surface is covered with additional inorganic binder 300. The inorganic binder is added to the surface in an uncured state and then cured in place. Preferably, the inorganic binder 300 cures at room temperature for easier installation on site. In another embodiment, the inorganic binder 300 cures at an elevated temperature (greater than room temperature). Next, optionally an insulation layer 500 is added to the system adjacent the outer facing surface 100a covering at least a portion (and preferably all) of the pultruded elements 200. Once the fiber reinforcing polymer strengthening system is constructed, the system preferably has fire resistance providing a fire rating standard when tested, such as ASTM E-119.

### EXAMPLES

The invention will now be described with reference to the following non-limiting examples, in which all parts and percentages are by weight unless otherwise indicated.

### Example 1

The first example was a carbon fiber pultruded element. The carbon fibers were a single 24 k carbon fiber tow (sized for epoxy resins) Toray T700SC available from Composites One. The matrix material used was DEN® 438 available from Dow Corporation with Diamino diphenyl sulfone (DDS), trade name DAPSONE®. The tows were submerged in a bath of the matrix material, pulled through a die, and cured for 3 hours at 177° C. then for 2 hours at 250° C. The resulting pultruded elements contained approximately 50% fiber by volume and had a nominal diameter of approximately 1.5 mm.

### Example 2

The pultruded elements of Example 1 were cut to 8 inches (20.32 cm) and submerged in a heated bath of EPON 828 available from DOW Chemical and MCDEA (a bisphenol-A based resin with an aromatic amine having a T_{g} of approximately 220° C.) available from Synasia. After removing excess resin, the pultruded elements were coated or “salted” with coarsely ground sand and cured at a temperature of 150° C. overnight.

### Example 3

The pultruded elements of Example 1 were cut to an 8 inches (20.32 cm) and submerged in a heated bath of DEN 438 with DDS. After removing excess resin, the pultruded elements were coated or “salted” with coarsely ground sand. The pultruded elements were then cured for 3 hours at 177° C. then for 2 hours at 250° C.

### Example 4

Example 4 was a commercially available pultruded carbon rod available from Goodwinds having a T_{g} below 250° C.

### Example 5

A pultruded carbon rod from Example 4 was wrapped with a single carbon tow (single 12 k tow from a BASF fabric, CF130) using a low T_{g} 71° C. (163° F.) epoxy binder (MBRACE® epoxy available from BASF) and cured at room temperature overnight.

### Example 6

Example 6 was commercially available fabric CF130 from BASF fabric which was a unidirectional fabric having ten 12 k carbon tows per inch and a glass fiber in the warp. The fibers in the yarn bundles making up the fabric were bonded (glued together) using MBRACE® saturant available from BASF. The MBRACE® saturant was a bisphenol based A diglycidyl ether resin cured with a mixture of aliphatic amines.

The pultruded elements were tested for the retention of tensile strength and ability to transfer load to a matrix at 250° C. Tabs were attached to the pultruded elements and tensile strength was measured at room temperature and at 250° C. The results are noted in the following table. Samples were normalized to the amount of carbon fiber in each sample (one 24 k tow from the pultruded elements of Example 1 is ⅕ the carbon of a 1″ wide CF-130 fabric).

TABLE 1

| | Tensile strength at | Tensile strength at | % of strength |
|---|---|---|---|
| Sample | room temperature (MPa) | 250° C. (MPa) | retained |
| Ex. 1 | 30.3 | 32.4 | 107 |
| Ex. 6 | 29.0 | Sample failed, | Sample failed, |
| | | could not | could not |
| | | be tested | be tested |

As one can see from Table 1, Example 6 failed when the sample was taken to a temperature of 250° C. and tested. The tensile strength of Example 1 did not significantly change from room temperature to 250° C.

To measure the transfer of applied loads into a surrounding matrix through shear, lap shear specimens were created by embedding the pultruded elements from Example 1-6 into a mortar material (inorganic binder) attached to a concrete coupon. The mortar material for examples 1-3 was Phoscrete 601 P from Stellar Materials (Magnesium Oxide, Aluminum Oxide, and Mono Aluminum Liquid Phosphate activator). The mortar material for examples 4-5 was Grancrete HFR (Magnesium oxide, Potassium Dihydrogen phosphate, and Wollastonite). The measurement measures both the pultruded element and the inorganic binder with the failure mode exposing the weakest component. The coupon was gripped by a fixture, and the reinforcement was placed under tension by pulling at the opposite end. The strength of the pultruded elements/inorganic binder combination is reported in the following table.

TABLE 2

| | Peak | Peak | | |
|---|---|---|---|---|
| | Load at | Load at | % | |
| | RT | 250° C. | strength | |
| Sample | (lb_{f}) | (lb_{f}) | retained | Failure mode |
| Ex. 1 | 1701 | 1992 | 117% | Rods slipped from mortar at both |
| | | | | temperatures |
| Ex. 2 | 2144 | 1503 | 70% | Failure of multiple components at |
| | | | | RT; pultruded rod slipped away |
| | | | | from sand at 250° C. |
| Ex. 4 | 1575 | Not | Not | Rods slipped at RT. Did not test |
| | | tested | tested | at 250° C. because the sample |
| | | | | had a lower T_{g} resin (below 110° |
| | | | | C.) and would fail before |
| | | | | reaching 250° C. |
| Ex. 5 | 2639 | Not | Not | Concrete and mortar failure at |
| | | tested | tested | RT. Did not test at 250° C. |
| | | | | because the sample had a lower |
| | | | | T_{g} resin (below 110° C.) and |
| | | | | would fail before reaching 250° C. |
| Ex. 6 | 1800 | 153 | 8.5% | Concrete failure at RT, matrix |
| | | | | slipping at 250° C. |

Examples 1 and 2 demonstrate room temperature performance equivalent or greater than control example 6. At elevated temperature (250 C), examples 1 and 2 retain a significant percentage of the room temperature strength while example 6 lost more than 90% of its strength. Example 5 demonstrates increased strength over Example 4 by addition of surface features at the pultruded rod. To further measure the transfer of applied loads into a surrounding matrix through shear, a small concrete 4″×4″×14″ beam made with a pre-blended concrete mix capable of developing 5000 psi compressive strength was strengthened by embedding the pultruded elements in an inorganic binder on the surface of the beam (externally bonded). The inorganic matrices used were Phoscrete 601 P from Stellar Materials (Magnesium Oxide, Aluminum Oxide, and Mono Aluminum Liquid Phosphate activator), Grancrete HFR from Grancrete Inc (Magnesium oxide, Potassium Dihydrogen phosphate, and Wollastonite mixed), and Pavemend VR from Ceratech (Magnesium Phosphate and OPC blend). The beam was measured in 3-point bend method at room temperature and at 250° C.

TABLE 3

| | | | Peak | Peak | % | |
|---|---|---|---|---|---|---|
| Sam- | Mounting | Inorganic | Load at | Load at | strength | |
| ple | Method | Binder | RT (lbf) | 250° C. | retained | Failure mode |
| Ex. 1 | Externally | Phoscrete | Not | 2798 | n/a | Mortar |
| | bonded | 601P | tested | | | cracking/rod |
| | | | | | | slipping |
| Ex. 3 | Externally | Phoscrete | 3521 | 3470 | 99% | Concrete |
| | bonded | 601P | | | | failure at |
| | | | | | | both |
| Ex. 6 | Externally | Mbrace | 3733 | 983 @ | 15% | Concrete |
| | bonded | Saturant | | 90° C. | | shear @ RT, |
| | | | | | | delamination |
| | | | | | | at 90° C. |

The various configurations for examples 1 and 3 in Table 3 show the peak load at 250° C. compared to the peak load on control example 6 at room temperature. Example 1 showed dramatic improvement over control example 6 at 250° C., but failed due to rod slippage. Example 3 externally bonded drove the failure mode into the concrete and nearly matched the RT performance of control example 6. All examples 1 and 3 tested at 250° C. far exceeded the performance of control example 6 at 90° C. Examples 1 and 3 used 8 fasteners in each of the beams.

### Examples 7-16

Various insulation boards, blankets, and coatings were tested. Each insulation was mounted against a 4″×4″×2″ concrete coupon. The coupon was placed over an open furnace with the insulation facing in, and the furnace was heated to 1100° C. while the thermocouple temperature was monitored.

TABLE 4

| | | Tested |
|---|---|---|
| Sample | Insulation description | thickness |
| Ex. 7 | Duraboard from Unifrax (ceramic fibers and | 1 inch |
| | small fraction of organic binding agents), | |
| | attached with a high temperature cement glue, | |
| | Omegabond from Omega | |
| Ex. 8 | Driclad board from Albi Manufacturing (semi- | 1 inch |
| | rigid board from molten volcanic rock | |
| | (rockwool), plus binder) attached with | |
| | Pyrocrete 241 from Carboline | |
| Ex. 9 | Pyrocrete 241 from Carboline (cementitious, | 1 inch |
| | spray or trowel-applied insulation of cement, | |
| | vermiculite, gypsum, fibers, and lightweight | |
| | aggregate), self-adhered | |
| Ex. 10 | Monokote Z146 from Grace (cementitious, | 1 inch |
| | spray- or trowel-applied insulation of cement, | |
| | vermiculite, gypsum, fibers, and lightweight | |
| | aggregate), self-adhered | |
| Ex. 11 | Monokote Z146 from Grace enveloping a 10 | 1 inch |
| | mm aerogel blanket (Pyrogel XT from Aspen | |
| | Aerogel consisting of silica aerogel and | |
| | glass fiber blanket), self-adhered | |
| Ex. 12 | Flexible Ceramic insulation blanket from | 1 inch |
| | McMaster-Carr, in contact with concrete | |
| Ex. 13 | Clad TF from Albi Manufacturing (An | 0.67 inch |
| | intumescent paint), self-adhered | |
| Ex. 14 | An ordinary Portland cement with hollow | 1 inch |
| | Cenospheres from PQ Corporation (ceramic | |
| | hollow microspheres), self-adhered | |
| Ex. 15 | 1″ Driclad board from Albi Manufacturing | 1.5 inch |
| | (Ex. 24) attached with Pyrocrete 241 from | |
| | Carboline to the concrete coupon, and then | |
| | on the outer side of the Driclad, attaching a | |
| | ½″ Duraboard from Unifrax (Ex. 22) via | |
| | Ceramabond 813A ceramic glue from Aremco | |

Temperature recordings for 1, 2, 3 and 4 hours is noted in the table below.

TABLE 5

| Sample | 1 hour | 2 hour | 3 hour | 4 hour |
|---|---|---|---|---|
| Ex. 7 | 186° C. | 282° C. | 345° C. | 373° C. |
| Ex. 8 | 189° C. | 284° C. | 348° C. | 379° C. |
| Ex. 9 | 115° C. | 302° C. | 370° C. | Not tested |
| Ex. 10 | 207° C. | 309° C. | 343° C. | 415° C. |
| Ex. 11 | 180° C. | 287° C. | 354° C. | 382° C. |
| Ex. 12 | 170° C. | 264° C. | 335° C. | Not tested |
| Ex. 13 | 97° C. | 184° C. | 256° C. | 323° C. |
| Ex. 14 | 215° C. | 354° C. | 379° C. | Not tested |
| Ex. 15 | 114° C. | 168° C. | 196° C. | 218° C. |

Table 5 shows temperature recordings at each hour up to four hours of constant exposure to the open furnace. Each sample formed a tight fit in the furnace opening, minimizing heat transfer around the edges. Temperature recordings in Table 5 show the monitored temperature at the center of the coupon at the interface of the concrete coupon and insulation. Some examples, such as Examples 10 and 11 show a lower increase in temperature during the first hour followed by a faster rise in temperature after the first hour due to the release of water in the system, acting as an initial heat sink. Examples 7-15 show the performance of each system at equivalent thicknesses over a four hour exposure period.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fiber reinforced polymer strengthening system comprising:
a concrete structural member having at least one outer facing surface;
at least one pultruded element on the outer facing surface of the concrete structural member comprising a matrix material having a T_{g} of at least about 110° C. and a plurality of fibers having a tensile strength of at least about 300 MPa and an operating temperature of at least the T_{g} of the matrix material; and,
an inorganic binder comprising an inorganic material having an operating temperature of at least about T_{g} of the matrix material of the pultruded element, wherein the inorganic material is incombustible, and wherein the inorganic binder is adjacent the outer facing surface of the concrete structural member and at least partially covering the at least one pultruded element.

2. The fiber reinforced polymer strengthening system of claim 1, wherein the fiber reinforced polymer strengthening system further comprises an insulation layer, wherein the insulation layer is adjacent the outer facing surface of the concrete structural member covering a least a portion the inorganic binder and pultruded elements.

3. The fiber reinforced polymer strengthening system of claim 2, wherein the insulation layer is attached to the outer facing surface of the concrete structural member with an adhesive having a T_{g} of at least about the T_{g} of the matrix material in the pultruded element.

4. The fiber reinforced polymer strengthening system of claim 2, wherein the insulation layer is attached to the outer facing surface of the concrete structural member with a mechanical means.

5. The fiber reinforced polymer strengthening system of claim 1, wherein the at least one pultruded element further comprises a roughened surface texture.

6. The fiber reinforced polymer strengthening system of claim 1, wherein the at least one pultruded element comprises additional fibers wrapping the pultruded element.

7. The fiber reinforced polymer strengthening system of claim 1, wherein the fiber reinforced polymer strengthening system passes the ASTM E-119 test.

8. The fiber reinforced polymer strengthening system of claim 1, wherein the concrete structural member is selected from the group consisting of a slab, beam, joist, pillar, and column.

9. The fiber reinforced polymer strengthening system of claim 1, wherein the inorganic binder comprises cementitious material.

10. The fiber reinforced polymer strengthening system of claim 1, wherein the system further comprises fasteners, wherein the fasteners extend through the inorganic binder into the concrete structural member.

11. A fiber reinforced structure comprising the fiber reinforced polymer strengthening system of claim 1, wherein the structure is selected from the group consisting of a building and a bridge.

12. The method of forming a fiber reinforced polymer strengthening system comprising:
obtaining a preformed and cured concrete structural member having at least one outer facing surface;
placing at least one pultruded element on at least one outer facing surface of the structural member, wherein the at least one pultruded element comprises a matrix material having a T_{g} of at least about 110° C. and a plurality of fibers having a tensile strength of at least about 300 MPa and an operating temperature of at least the T_{g} of the matrix material and adding an uncured inorganic binder at least partially surrounding the at least one pultruded element, wherein the uncured inorganic binder comprises an uncured inorganic material; and,
curing the uncured inorganic binder forming an inorganic binder having an operating temperature of at least about the T_{g} of the matrix material of the pultruded element and is incombustible.

13. The method of claim 12, further comprising the step of adhering an insulation layer to the outer facing surface of the concrete structure, wherein the insulation layer at least partially covers the at least one pultruded element.

14. The method of claim 13, wherein the insulation layer is adhered to the cured inorganic binder located on the outer facing surface of the concrete structure using the inorganic binder.

15. The method of claim 13, wherein the insulation layer is adhered to the cured inorganic binder located on the outer facing surface of the concrete structure using a mechanical fastener.

16. The method of claim 12, wherein the preformed and cured concrete structural member is part of an existing structural system.

17. The method of claim 12, wherein the inorganic binder comprises cementitious material.

18. The method of claim 12, wherein the concrete structural member is selected from the group consisting of a slab, beam, joist, pillar, and column.

19. The method of claim 12, wherein curing the uncured inorganic binder is performed at room temperature.

20. A fiber reinforced polymer strengthening system formed by the process of claim 12.
